(19) United States
(12) Patent Application Publication
(10) Pub. No.: US 2011/0192258 A1
(43) Pub. Date: Aug. 11, 2011

(54) RATCHETING TOOL

(75) Inventor: Chih-Ching HSIEH, TAICHUNG COUNTY (TW)

(73) Assignee: Chih-Ching HSIEH, TAICHUNG COUNTY (TW)

(21) Appl. No.: 12/778,947

(22) Filed: May 12, 2010

(30) Foreign Application Priority Data
Feb. 8, 2010 (TW) 99103833

(51) Int. Cl. B25B 23/16; B25B 13/46; B25B 13/06; B25B 15/04

(52) U.S. Cl. 81/60; 81/177.7; 81/121.1; 81/460

(57) ABSTRACT

A hand tool includes a handle, a first shank portion, a second shank portion, a hinge, a fitting and a ratchet. The first shank portion is connected to the handle. The hinge pivotally connects the second shank portion to the first shank portion. The ratchet connects the fitting to the second shank portion.

### RELATED APPLICATIONS

The application claims priority to Taiwan Application Serial Number 99103833, filed Feb. 8, 2010, which is herein incorporated by reference.

### BACKGROUND

1. Technical Field

The present disclosure relates to hand tools.

2. Description of Related Art

Hand tools are the most common tools of general home and factory. Hand tools include pliers, wrenches, screwdrivers, hammers and so on.

In normal operation, hand tools must be applied to a variety of work pieces. However, the work pieces are located at different positions respectively. Therefore, users often change the acting angle between the hand tool and the work piece with their wrist, which leads to wrist injury.

### SUMMARY

According to one embodiment, a hand tool includes a handle, a first shank portion, a second shank portion, a hinge, a fitting and a ratchet. The first shank portion is connected to the handle. The hinge pivotally connects the second shank portion to the first shank portion. The ratchet connects the fitting to the second shank portion.

According to another embodiment, a hand tool includes a handle, a shank, a fitting and a ratchet. The shank is connected to the handle. The ratchet connects the fitting to the end of the shank.

### BRIEF DESCRIPTION OF THE DRAWINGS

FIG. 1 is a three dimensional view of a hand tool according to one embodiment;

FIG. 2 is a three dimensional view of a hand tool according to another embodiment;

FIG. 3 is a three dimensional view of the hand tool of FIG. 2 in use;

FIG. 4A is a cross-sectional view of the hinge of FIG. 2;

FIG. 4B is a cross-sectional view of the hinge of FIG. 2 in use;

FIG. 5 is a side view of the hand tool of FIG. 2 in use; and

FIG. 6 is a three dimensional view of a hand tool according to yet another embodiment.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically depicted in order to simplify the drawings.

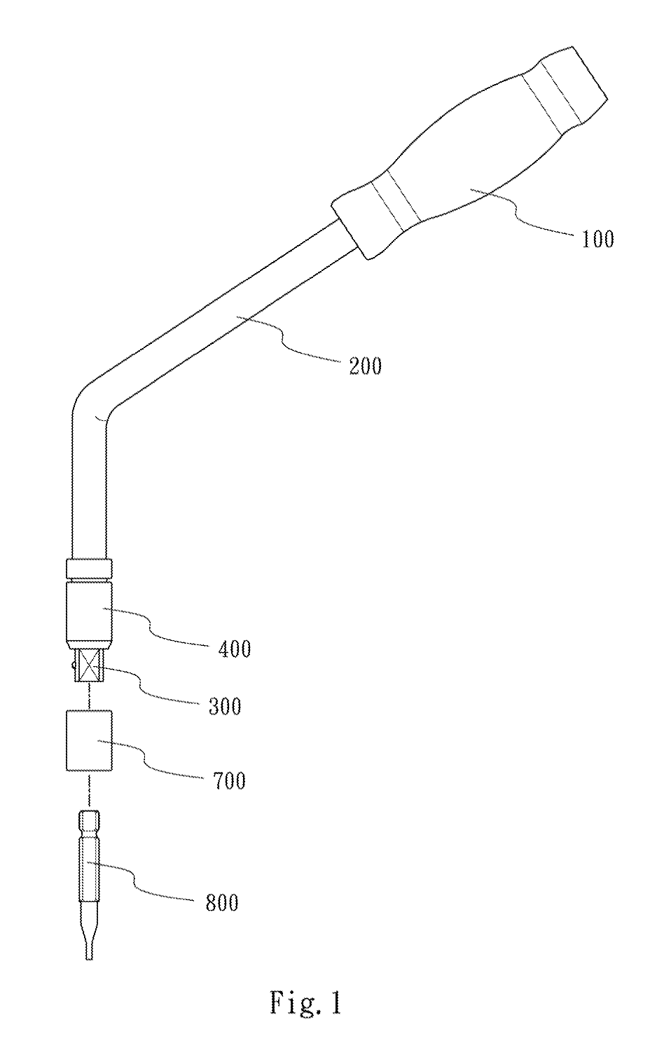

FIG. 1 is a three dimensional view of a hand tool according to one embodiment. The hand tool includes a handle 100, a shank 200, a fitting 300 and a ratchet 400. The shank 200 is connected to the handle 100. The ratchet 400 connects the fitting 300 to the end of the shank 200.

In detail, the shank 200 is L-shaped. In use, the bend angle of the L-shaped shank 200 can be applied to many work pieces, which can be at different positions respectively.

In FIG. 1, the hand tool further includes a socket 700 and a driving head 800. The socket 700 is detachably connected to the fitting 300. The socket 700 can be a hex socket, a 12-point socket, or a square socket. The driving head 800 is detachably connected to the socket 700. The driving head 800 can be a slotted head or a Phillips head.

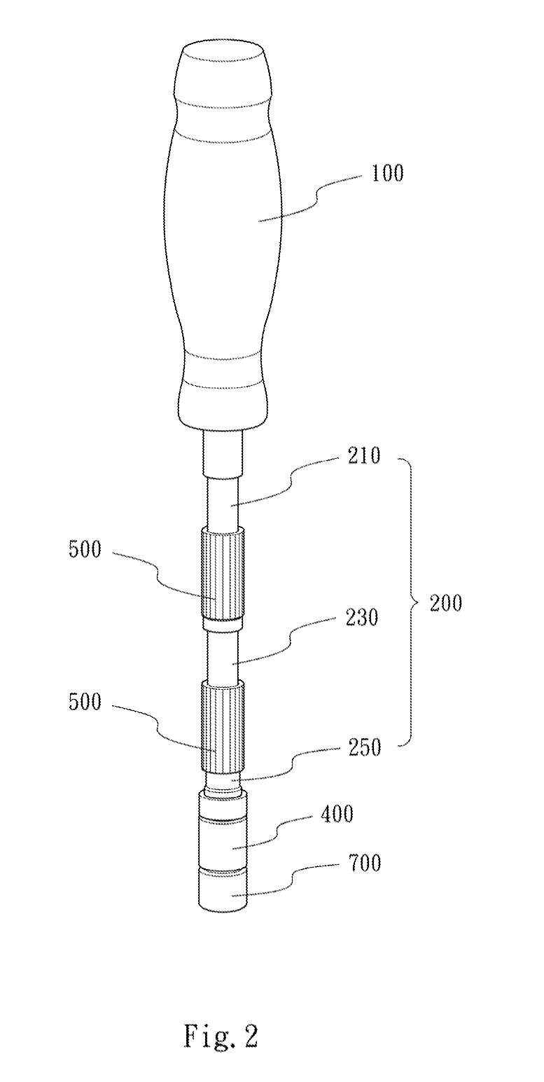

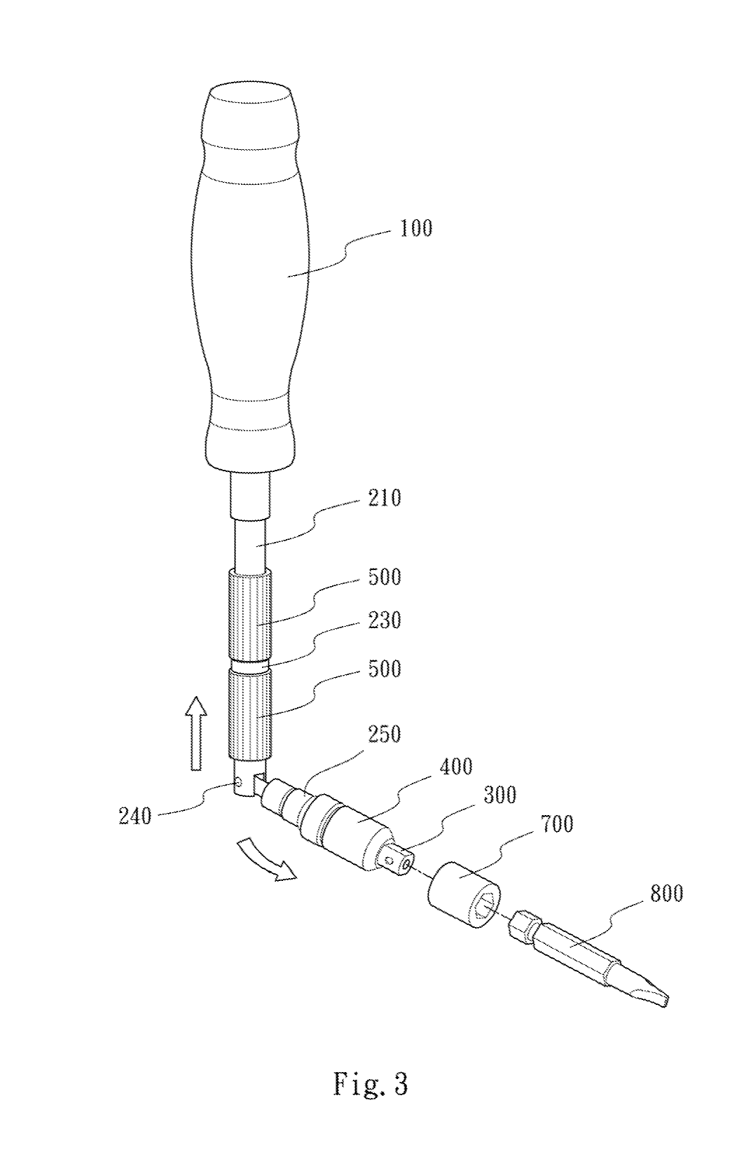

FIG. 2 is a three dimensional view of a hand tool according to another embodiment. FIG. 3 is a three dimensional view of the hand tool of FIG. 2 in use. In FIG. 2, the shank 200 includes a first shank portion 210, a second shank portion 230 and a third shank portion 250. The second shank portion 230 is pivotally connected to the first shank portion 210. The third shank portion 250 is pivotally connected to the second shank portion 230, wherein the ratchet 400 connects the fitting 300 to the third shank portion 250 of the shank 200.

In FIG. 3, the hand tool includes a hinge 240. The hinge 240 pivotally connects the third shank portion 250 to the second shank portion 230.

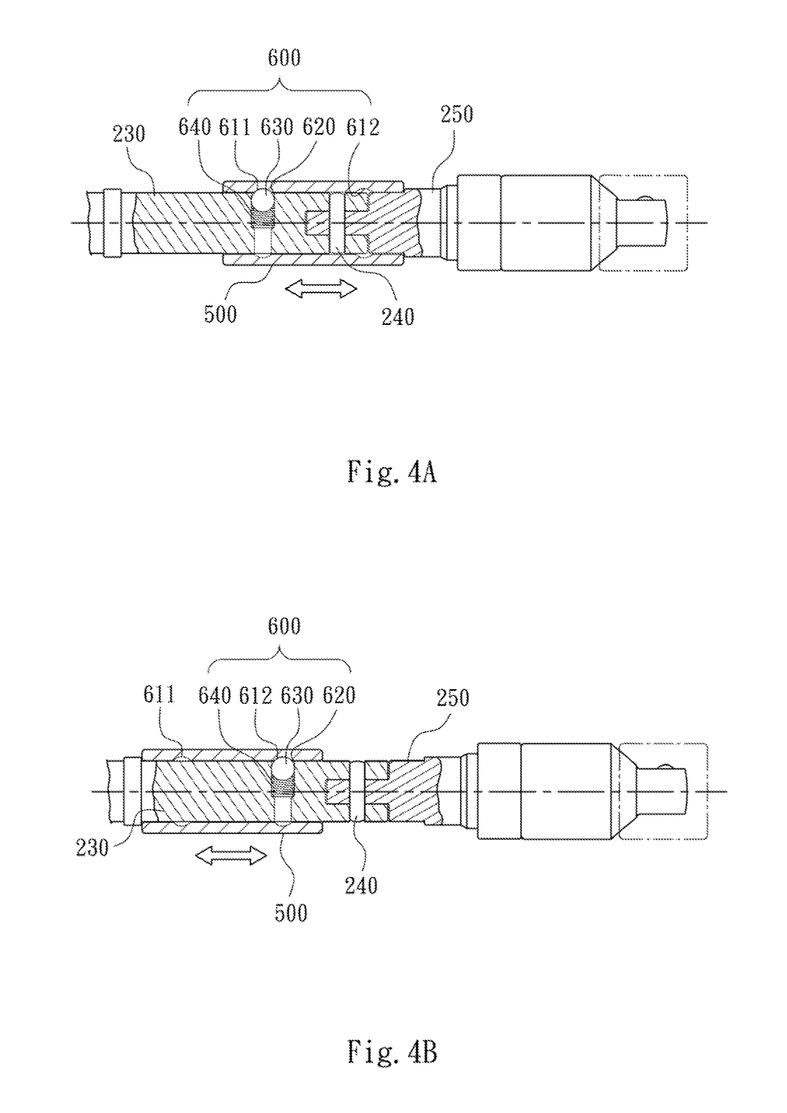

FIG. 4A is a cross-sectional view of the hinge 240 of FIG. 2. FIG. 4B is a cross-sectional view of the hinge 240 of FIG. 2 in use. For restricting and pivoting the hinge 240, the hand tool further includes a sleeve 500 and a ball detent 600. The sleeve 500 is slidably disposed about the hinge 240. The ball detent 600 can hold the sleeve 500 in a temporarily fixed position relative to the hinge 240. In other words, the sleeve 500 is slidably disposed about the pivot joint (hinge 240) between the second shank portion 230 and the third shank portion 250. The ball detent 600 can hold the sleeve 500 in a temporarily fixed position relative to the pivot joint (hinge 240) between the second shank portion 230 and the third shank portion 250.

In detail, the ball detent 600 includes at least one recess, a hole 620, at least one ball 630 and at least one spring 640. In FIGS. 4A and 4B, the ball detent 600 includes a plurality of recesses 611, 612. The recesses 611, 612 are in the inner surface of the sleeve 500. The hole 620 is located in the second shank portion 230. The ball 630 is slidably received in the hole 620. The spring 640 is received in the hole 620 for pushing the ball 630 to engage one of the recesses 611, 612.

In other words, the sleeve 500 covers the hinge 240 for restricting the hinge 240. In use, the user can move the sleeve 500. In FIG. 4B, when the ball 630 engages from a recess 611 to another recess 612, the hinge 240 can depart from restricting of the sleeve 500. Then, the second shank portion 230 and the third shank portion 250 can be pivoted to a predetermined angle.

In addition, the outer diameter of the ratchet 400 is substantially equal to the outer diameter of the sleeve 500. Therefore, the ratchet 400 and the sleeve 500 can be entered into the narrow work piece with the fitting 300.

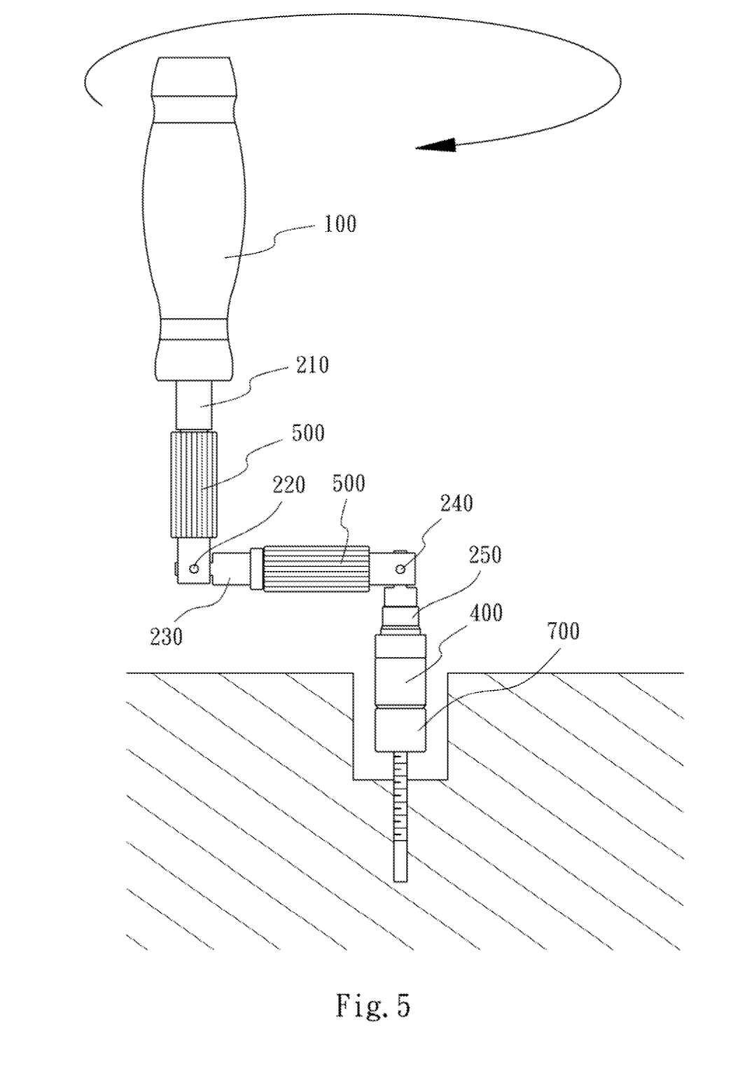

FIG. 5 is a three dimensional view of the hand tool of FIG. 2 in use. The hand tool further includes a hinge 220, which pivotally connects the first shank portion 210 and the second shank portion 230. Therefore, the first shank portion 210 and the second shank portion 230 also can be pivoted to a predetermined angle via the hinge 220. The hand tool also includes another sleeve 500 and ball detent 600 (as FIGS. 4A and 4B) for restricting the hinge 220. Therefore, the angle between the first shank portion 210 and the second shank portion 230 also can be changed when the hand tool is applied to the different work pieces.

In addition, the hand tool includes a socket 700 and a driving head 800. In FIG. 3, the socket 700 is a hex socket. The driving head 800 is a slotted head. The socket 700 is detachably connected to the fitting 300. The driving head 800 is detachably connected to the socket. Therefore, the hand tool can be applied to the different type of work pieces.

Furthermore, the driving head 800 also can be a Phillips head. The socket 700 also can be a 12-point socket, or a square socket.

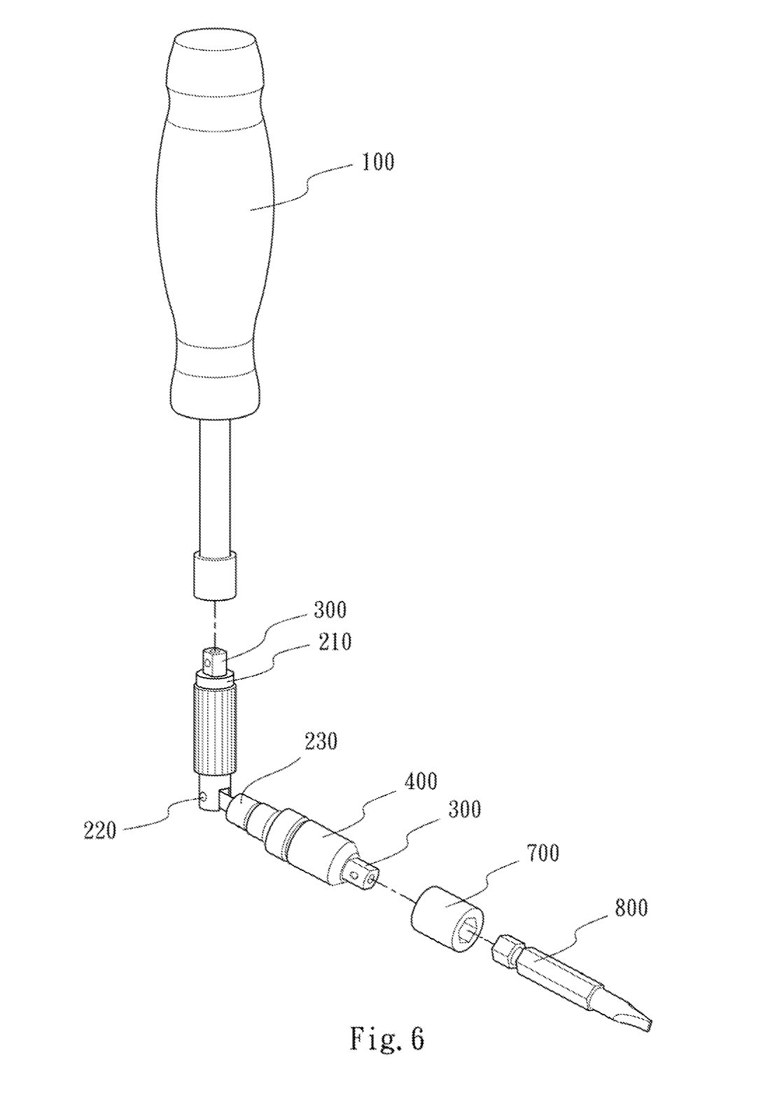

FIG. 6 is a three dimensional view of a hand tool according to yet another embodiment. In FIG. 6, one end of the first shank portion 210 is pivotally connected to the second shank portion 230 via the hinge 220. The other end of the first shank portion 210 is connected to a fitting 300. The fitting 300 can be detachably connected to the handle 100 (in FIG. 2) or another work member, e.g. the socket 700.

The reader's attention is directed to all papers and documents which are filed concurrently with his specification and which are open to public inspection with this specification, and the contents of all such papers and documents are incorporated herein by reference.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112, 6th paragraph. In particular, the use of “step of” in the claims is not intended to invoke the provisions of 35 U.S.C. §112, 6th paragraph.

What is claimed is:

1. A hand tool comprising:
a handle;
a first shank portion connected to the handle;
a second shank portion;
a hinge pivotally connecting the second shank portion to the first shank portion;
a fitting; and
a ratchet connecting the fitting to the second shank portion.

2. The hand tool of claim 1, further comprising:
a sleeve slidably disposed about the hinge.

3. The hand tool of claim 2, further comprising:
a ball detent for holding the sleeve in a temporarily fixed position relative to the hinge.

4. The hand tool of claim 2, wherein the ball detent comprises:
at least one recess in the inner surface of the sleeve;
a hole located in the first shank portion;
at least one ball slidably received in the hole; and
at least one spring received in the hole for pushing the ball to engage the recess.

5. The hand tool of claim 2, wherein the outer diameter of the ratchet is substantially equal to the outer diameter of the sleeve.

6. The hand tool of claim 1, further comprising:
a socket detachably connected to the fitting, wherein the socket is a hex socket, a 12-point socket, or a square socket.

7. The hand tool of claim 6, further comprising:
a driving head detachably connected to the socket, wherein the driving head is a slotted head or a Phillips head.

8. A hand tool comprising:
a handle;
a shank connected to the handle;
a fitting; and
a ratchet connecting the fitting to the end of the shank.

9. The hand tool of claim 8, wherein the shank comprises:
a first shank portion connected to the handle;
a second shank portion, wherein the ratchet connects the fitting to the second shank portion of the shank; and
a hinge pivotally connecting the second shank portion to the first shank portion.

10. The hand tool of claim 9, further comprising:
a sleeve slidably disposed about the hinge of the shank.

11. The hand tool of claim 10, further comprising:
a ball detent for holding the sleeve in a temporarily fixed position relative to the hinge of the shank.

12. The hand tool of claim 10, wherein the ball detent comprises:
at least one recess in the inner surface of the sleeve;
a hole located in the shank;
at least one ball slidably received in the hole;
at least one spring received in the hole for pushing the ball to engage the recess.

13. The hand tool of claim 10, wherein the outer diameter of the ratchet is substantially equal to the outer diameter of the sleeve.

14. The hand tool of claim 8, wherein the shank comprises:
a first shank portion connected to the handle;
a second shank portion pivotally connected to the first shank portion; and
a third shank portion pivotally connected to the second shank portion, wherein the ratchet connects the fitting to the third shank portion of the shank.

15. The hand tool of claim 14, further comprising:
a sleeve slidably disposed about the pivot joint between the first shank portion and the second shank portion.

16. The hand tool of claim 15, further comprising:
a ball detent for holding the sleeve in a temporarily fixed position relative to the pivot joint between the first shank portion and the second shank portion.

17. The hand tool of claim 14, further comprising:
a sleeve slidably disposed about the pivot joint between the second shank portion and the third shank portion.

18. The hand tool of claim 17, further comprising:
a ball detent for holding the sleeve in a temporarily fixed position relative to the pivot joint between the second shank portion and the third shank portion.

19. The hand tool of claim 8, further comprising:
a socket detachably connected to the fitting, wherein the socket is a hex socket, a 12-point socket, or a square socket.

20. The hand tool of claim 19, further comprising:
a driving head detachably connected to the socket, wherein the driving head is a slotted head or a Phillips head.
